(19) United States
(12) Patent Application Publication
(10) Pub. No.: US 2017/0259275 A1
(43) Pub. Date: Sep. 14, 2017

(54) PROCESS FOR SEPARATING AMINO AND/OR ORGANIC ACID-CONTAINING PARTICLES FROM A MIXTURE

(71) Applicant: Sanovations B.V., Groningen (NL)

(72) Inventor: Johan Pieter Marinus Sanders, Groningen (NL)

(21) Appl. No.: 15/529,845

(22) PCT Filed: Nov. 25, 2015
(86) PCT No.: PCT/NL2015/050825

§ 371 Date: May 25, 2017

(30) Foreign Application Priority Data
Nov. 25, 2014 (NL) 2013874

(51) Int. Cl. B03B 5/44; B03B 5/34; A23L 2/66; A23K 20/142; A23L 33/175

(52) U.S. Cl. CPC B03B 5/442; A23K 20/142; A23L 33/175; A23L 2/66; B03B 5/34; A23V 2002/00

(57) ABSTRACT

A method for separating amino and/or organic acid-containing particles from a mixture of amino and/or organic acid-containing particles based on density is disclosed, the method comprising: providing a feed of the amino and/or organic acid-containing particles; providing a medium having a selected density effective for particles of a lower density than the selected density to float in the medium for particles of a higher density than the selected density to sink in the medium; combining the feed of the amino and/or organic acid-containing particles with the medium; and separating the amino and/or organic acid-containing particles of the higher density from the amino and/or organic acid-containing particles of the lower density.

### CROSS-REFERENCE TO RELATED APPLICATIONS

This application is a national phase entry under 35 U.S.C. §371 of International Patent Application PCT/NL2015/050825, filed Nov. 25, 2015, designating the United States of America and published in English as International Patent Publication WO 2016/085338 A1 on Jun. 2, 2016, which claims the benefit under Article 8 of the Patent Cooperation Treaty to Netherlands Patent Application Serial No. 2013874, filed Nov. 25, 2014.

### TECHNICAL FIELD

This application relates to methods for separating amino and/or organic acid-containing particles from a mixture of amino and/or organic acid-containing particles based on the density of the particles and to amino and/or organic acid-fractions thus obtained. The disclosure provides for batch as well as continuous processes and under ambient or increased gravitational forces.

### BACKGROUND

Proteins consist of twenty different amino acids of which nine are “essential” because monogastric organisms cannot synthesize these on their own. The cost of feed for pigs and poultry can be lowered by adding amino acids that are the most limiting in cheap bulk protein sources such as cornflower meal, rape meal, sunflower meal, etc. Two amino acids, lysine and methionine, have large application (1 million ton/year), while threonine is a fast-growing product, now 100,000 tons, and the number 4 is tryptophan, which is small in volume (10,000 tons). Tryptophan and the other essential amino acids are currently too expensive for most animal feed applications. Even if one of them would be available at low cost, the absence of the other would prevent their use in feed. Glutamic acid is also applied at large scale (>1 Mton/year) as a taste enhancer in human food. Almost all 20 amino acids find an application as food ingredients for hospital or sport food, for special diets or as ingredient in flavor and fragrance applications.

Amino acids can also be used as building blocks for (bulk) chemical products. Their actual cost, even of the three amino acids that are produced on a large scale (lysine, methionine and glutamic acid, which is used as a taste enhancer) is too high for the production of bulk chemicals.

Typically, amino acids are produced by fermentation, by chemical synthesis and by extraction from proteins. Their purification is done by ion exchange or by precipitation from water in which the desired amino acid is present in high concentration.

However, there is still a need for a more efficient and cost-effective production of amino acids and a need to isolate and separate amino acids from mixtures of amino acids and other complex starting compositions that contain amino acids.

Many complex starting compositions of amino acids also contain organic acids. Starting compositions according to the disclosure may also contain organic acids but are devoid of amino acids. There is also a growing need for cheap organic acids and for the improved use of organic feed streams.

### BRIEF SUMMARY

This disclosure provides methods for achieving these and other goals and will lower the cost of production of most or all amino acids.

The amino acids provided by the disclosure can find their application in animal feed.

The amino acids and/or organic acids provided by the disclosure can be used as chemical building blocks.

It has been found that a fraction enriched in selected amino and/or organic acid-containing particles can be obtained from a mixture of amino and/or organic acid-containing particles by subjecting the mixture of amino and/or organic acid-containing particles to a separation step in a medium of a density, wherein amino and/or organic acid-containing particles that have a density that is lower than the density of the medium will float (lighter fraction) and amino and/or organic acid-containing particles that have a density that is lower than the density of the medium will sink (heavier fraction). Accordingly, the disclosure relates in one aspect to a method or process for separating amino and/or organic acid-containing particles from a mixture of amino and/or organic acid-containing particles based on density, comprising:
providing a feed of the amino and/or organic acid-containing particles
providing a medium having a selected density effective for particles of a lower density than the selected density to float in the medium for particles of a higher density than the selected density to sink in the medium;
adding the feed of the amino and/or organic acid-containing particles to the medium; and
separating the amino and/or organic acid-containing particles of the higher density from the amino and/or organic acid-containing particles of the lower density.

The method according to the disclosure in one aspect is particularly suitable to separate amino and/or organic acid-containing particles from a mixture of amino and/or organic acid-containing particles that has been obtained from a feed and the method provides fractions of amino and/or organic acid-containing particles that are enriched or depleted in certain amino and/or organic acids compared to the composition of the starting mixture of amino and/or organic acid-containing particles.

Furthermore in another aspect, the disclosure pertains to amino and/or organic acid-containing particles that are obtained by the process of the disclosure.

### DETAILED DESCRIPTION

Thus, the disclosure pertains to a method for separating amino and/or organic acid-containing particles from a mixture of amino and/or organic acid-containing particles based on density, comprising:
providing a feed of the amino and/or organic acid-containing particles;
providing a medium having a selected density effective for particles of a lower density than the selected density to float in the medium for particles of a higher density than the selected density to sink in the medium;
combining the feed of the amino and/or organic acid-containing particles with the medium; and
separating the amino and/or organic acid-containing particles of the higher density from the amino and/or organic acid-containing particles of the lower density.

The method of the disclosure starts with the provision of a feed of amino and/or organic acid-containing particles. The feed can be any feed, but there is a preference for a feed that is a stream originating from an (agro) industrial scale process or is a waste product from an (agro) industrial process. Examples thereof are given below. The feed of amino and/or organic acid-containing particles can be any feed, but is preferably a feed that is obtained from a process wherein a feed comprising amino and/or organic acids is converted into amino and/or organic acid-containing particles, such as a crystallization process or a solidification process. Such a process can be in the form of subjecting a feed comprising amino and/or organic acids, preferably in a solution or a slurry, to a process wherein the solvent is removed from the mixture (for instance, by evaporation) or an anti-solvent such as ethanol or 1-butanol is added. As a result, amino and/or organic acid-containing particles are obtained that may have a different composition due to differences in the crystallization or solidification properties for different amino and/or organic acids (for instance, an acidic amino acid may crystallize at a different moment than a polar amino acid), thereby leading to a mixture of amino and/or organic acid-containing particles. The present method separates this mixture of amino and/or organic acid-containing particles into fractions that are enriched in certain amino and/or organic acids and/or depleted in other amino and/or organic acids. These fractions are separated based on their density or relative density compared to a medium. The separation step of the present method is preferably based on equilibrium separation (sink/float) rather than kinetic separation (centrifugal). Equilibrium separation can be supplemented by kinetic separation, i.e., wherein the centrifugal force is below 1000 g, preferably below 100 g. Practically, this can be accomplished in a semi-continuous centrifugal separation process at relative low g-forces, as indicated.

The feed comprising amino and/or organic acids that lays afoot to the feed of amino and/or organic acid-containing particles can be derived from Protamylasse, corn steep liquor, orange juice concentrate, grass juice, beet juice, protein hydrolysates, fermentation broths, mother liquids of crystallizations, sorghum juice, pineapple juice, molasses, vinasses, and the like. When these feeds comprising amino and/or organic acids are subjected to solidification and, in particular, crystallization conditions, depending on the particular amino and/or organic acid composition, they will crystallize/solidify into different amino and/or organic acid-containing particles as the various amino and/or organic acids will have a different solubility in the feed and, hence, crystallize at different rates and in different (mixed) compositions.

The medium used in the method of this disclosure has a selected density that is effective for particles of a lower density than the selected density to float in the medium and for particles of a higher density than the selected density to sink in the medium in which the particles do not or substantially not (less than 0.1 g/l) dissolve. To this end, the density of the medium is selected such that the difference between the lower and higher density is at least 0.01 g/cm³, preferably at least 0.05 g/cm³, more preferably at least 0.1 g/cm³.

The medium, in one embodiment, is selected from the group consisting of halogenated hydrocarbons, preferably fluorinated, chlorinated or brominated or combinations of hydrocarbons, trichlorofluoromethane, 1,1,2,2,tetrafluoromethane, chloropentafluoroethane, octafluorocyclobutane, tetrafluoroethane tetrabromoethane, dibromomethane, chloroform, bromoform, diodomethane, 1,10-diododecane, bromotrichloromethane, and ammonium and (earth)alkalitungstate solutions, (earth)alkalihalogen salt solutions, preferably CsCl, NaI, CaI₂, CaBr₂ and NH₄Br, bentonite suspensions as described in M. Asada and S. Horiuchi in J. Mater. Civ. Eng., 2005, 17:178-187. Preferably, the medium is selected from the group consisting of halogenated hydrocarbons, preferably fluorinated, chlorinated or brominated or combinations of hydrocarbons, trichlorofluoromethane, 1, 1,2,2,tetrafluoromethane chloropentafluoroethane, octafluorocyclobutane, tetrafluoroethane, tetrabromoethane, dibromomethane, chloroform, bromoform, diodomethane, 1,10-diododecane, and bromotrichloromethane. CsCl is less preferred as it is relatively unsuitable for industrial scale processes such as those of this disclosure.

In one embodiment, the medium has a density that is higher (at least 0.01 g/cm³, preferably at least 0.05 g/cm³, more preferably at least 0.1 g/cm³) than the highest density of the amino and/or organic acid-containing particles. The medium has preferably a density (rho) of from 1.1 g/cm³ to 5 g/cm³, preferably from 1.3 g/cm³ to 3 g/cm³, from 1.5 g/cm³ to 2.5 g/cm³. In alternative embodiments, aimed at separation of fractions containing particles of lesser density, such as those containing relative high yields of leucine and isoleucine, preferred ranges are from 1.01 g/cm³ to 5 g/cm³, preferably from 1.05 g/cm³ to 3 g/cm³, from 1.1 g/cm³ to 1.7 g/cm³.

Amino acids, in their solid form, preferably crystalline form, each have their own densities as indicated in the below table: The densities of several exemplary L-amino acids is described in: E. Berlin et al., J. Phys. Chem., 1968, 72 (6), pp 1887-1889. Other densities (in particular, for DL-amino acids and organic acids are described, for instance, in CRC Handbook of Chemistry and Physics 54^{th} ed., page C-724.

| | Aqueous Solubility | Crystal Density |
|---|---|---|
| Name | (g/100 g, 25° C.) | (g/cm³) |
| Alanine | 16.65 | 1.371 |
| Arginine | 15 | 1.325 |
| Aspartic Acid | 0.778 | 1.636 |
| Asparagine | 3.53 | — |
| Cysteine | 28 | 1.495 |
| Glutamic Acid | 0.864 | 1.566 |
| Glutamine | 2.5 | — |
| Glycine | 24.99 | 1.598 |
| Histidine | 4.19 | 1.412 |
| Isoleucine | 4.117 | 1.201 |
| Leucine | 2.426 | 1.167 |
| Lysine | 30 | 1.237 |
| Methionine | 3.381 | 1.311 |
| Phenylalanine | 2.965 | 1.315 |
| Proline | 162.3 | 1.376 |
| Serine | 5.023 | 1.582 |
| Threonine | 9 | 1.499 |
| Tryptophan | 1.136 | 1.303 |
| Tyrosine | 0.0453 | 1.403 |
| Valine | 8.85 | 1.267 |

Thus, a feed of the amino and/or organic acid-containing particles as a starting mixture contains fractions of amino and/or organic acid-containing particles that are rich in (or essentially consist of) a particular (combination of) amino and/or organic acids. Each of these fractions will have its own density, depending on its composition. These differences in densities of the fractions is exploited in this disclosure.

The density of the medium can be adjusted by combining the medium with a density-adjusting compound that is typically of a significantly different density than the medium. Preferably, the difference between the medium and the density-adjusting compound is more than about 0.5 g/cm³, preferably more than about 1 g/cm³, more preferably more than about 2 g/cm³, and most preferably more than about 3 g/cm³. Furthermore, the amino and/or organic acid-containing particles are essentially insoluble in the medium and/or the density-adjusting compound.

Previously, lab-scale processes have been described using density gradients (media of varying density) and (ultra-) centrifuges. For instance, Wofsey et al. (PNAS 1971, 68(6):1102-1106) describes the (lab scale) separation of tissue vesicles containing binding sites that recognize amino acids and other components and separates these loaded vesicles on a differential centrifugation in a sucrose density gradient ranging from 0.32 M sucrose to 1.5 M sucrose (densities from about 1.024-1.072 g/ml). The separation is based on kinetics and not on equilibrium. The separation needs 15 minutes at high gravitational forces (100,000*g), the concentrations of the amino acids are in the order of 10⁻⁸-10⁻⁷ M. The technology needs an ultracentrifuge and is only useful as an analytical tool. Furthermore, the method disclosed in Wofsey relies on relative density differences in the range of 1 M sucrose (about 1.072 g/ml) of crystalline amino-acids and/or organic acids, whereas the present method relies, among others, on the relative density differences of the amino or organic acid crystals. Another example of such a lab-based method is by Silpananta (Biochem. J., 1967, 104, 404) and describes the equilibrium centrifugation in CsCl gradients. Again, a density gradient technology that often is used for analytical purposes, can be used for preparative applications but still only in very small volumes since an ultracentrifuge is a required tool that needs high capital investment, high energy inputs and high labor costs and will not be used above the hundreds of milliliter scale. Silpananta describes the separation of single polymeric molecule proteins (chondromucoprotein) of 250,000 D and hyaluronic acid, a substituted carbohydrate polymer. This disclosure, however, employs a medium of a fixed density and not a density gradient.

The density-adjusting compound is preferably an alcohol, a diol or a polyol, preferably methanol, ethanol, n-propanol, iso-propanol), n-butanol, iso-butanol, glycol, glycerol and combinations thereof. To allow for recycling, it may be advantageous that the density-adjusting compound and the medium are recyclable, for instance, by distillation. For such purpose, the density-adjusting compound may have a boiling point that differs by at least 10 degrees Celsius from the medium. Alternatively, the density-adjusting compound may be extractable from the medium, for instance, by a different solubility in a solvent compared to the medium. For instance, in the case of ethanol (density-adjusting compound) and bromoform (medium), aqueous extraction may allow for separation of the ethanol from the bromoform.

The selected density of the medium can be determined by the skilled person with some initial, simple and small-scale experimentation. For instance, by starting with a medium such as bromoform and combining the feed with the bromoform (density 2.8 g/cm³), determines whether fractionation (floating and sinking fractions) occurs. Adding ethanol (density about 0.79 g/cm³) and allowing the mixture to settle, determines whether fractionation into fractions has occurred. This can be done in a separation funnel. By determining the composition of the fractions using conventional methods, the density can be adjusted to achieve the desired fractionation in the method of the disclosure.

In one embodiment, the medium and/or the density-adjusting medium are inert toward the amino and/or organic acid-containing particles. Furthermore, preferably, the amino and/or organic acids are essentially insoluble (or have a very low solubility) in the medium and/or the density-adjusting medium.

The amino and/or organic acid-containing particles are preferably, or contain, crystalline particles of amino and/or organic acids, salts of amino and/or organic acids as well as hydrates, co-crystals, co-crystallized amino and/or organic acids, etc., so is not limited to pure amino and/or organic acids.

The organic acids may be selected from amongst organic mono-acids, organic diacids and hydroxyacids. The organic acids may be selected from amongst lactic acid, 3-hydroxy propanoic acid, hydroxy butyric acid, hydroxy-valeric acid, oxalic acid, succinic acid, adipic acid, pimelinic acid, formic acid, acetic acid, propionic acid, butyric acid, malic acid, fumaric acid, itaconic acid, citric acid and glycolic acid.

As used herein, the notion “amino and/or organic acids” implies only amino acids, only organic acids or a combination of amino and organic acids.

The amino acids can be any amino acid and are, for instance, selected from the group consisting of alanine, arginine, aspartic acid, asparagine, cysteine, glutamic acid, glutamine, glycine, histidine, isoleucine, leucine, lysine, methionine, phenylalanine, proline, serine, threonine, tryptophan, tyrosine, valine, alpha butyric acid, gamma butyric acid, ornithine, taurine, and betaine.

Alternatively, the amino acids can be grouped into essential and non-essential amino acids, or grouped into aliphatic, hydroxylic/sulfuric/selenic, cyclic, aromatic, basic, acidic and amide amino acids or into polar and nonpolar amino acids as exemplified hereinbelow.

Essential amino acids: histidine, isoleucine, leucine, lysine, methionine, phenylalanine, threonine, tryptophan, and valine. Nonessential: alanine, arginine, asparagine, aspartic acid, cysteine, glutamic acid, glutamine, glycine, ornithine, proline, selenocysteine, serine, and tyrosine. Aliphatic: alanine, glycine, isoleucine, leucine, proline, and valine. Aromatic: phenylalanine, tryptophan, and tyrosine. Acidic: aspartic acid and glutamic acid. Basic: arginine, histidine, and lysine. Hydroxylic: serine and threonine. Sulphuric: cysteine and methionine. Amidic (containing amide group): asparagine and glutamine. Most amino acids exist in two stereoisomers, denoted as D or L. This disclosure focuses on amino acids obtained from natural sources that typically have an L-configuration. However, the disclosure may also relate to D-amino acids or mixtures of D and L.

This disclosure focuses on amino acids and their salts, but the disclosure may also relate to organic acids and the salts thereof. Examples of these are lactic acid, citric acid, malic acid, maleic acid, succinic acid, adipic acid, oxalic acid and their salts. With “salts” is typically meant the sodium, potassium, calcium and magnesium salts of the amino and organic acids.

The amino and/or organic acid-containing particles are combined with the medium (and, optionally, the density-adjusting compound). Combining may be by mixing, slurrying, spraying, etc. The slurry resulting from mixing may be left to stand or settle under ambient gravity in a settler or other suitable separation device. Alternatively, it may be subjected to increased gravity such as provided by a centrifugal force provided by, for example, a centrifuge, a hydrocyclone or a separator.

After the separation step, the two fractions (sinking and floating) are separated and isolated from the medium (with or without the density-adjusting compound) by sieving, filtration, or extraction. The amino and/or organic acid-containing fractions may be subjected to further purification steps such as recrystallization. In recrystallization, the crystals are dissolved in water or another solvent, preferably at elevated temperatures and as concentrated as possible, so that upon further crystallization, e.g., using anti-solvent crystallization, high yield of pure amino and/or organic acids can be obtained. Mixed amino and/or organic acid crystals and/or entrained mixtures of particles can be further purified in this way into pure amino and/or organic acid crystals.

Alternatively, the isolated fraction (sinking or floating), with or without removal of the medium, may be subject to a further separating step based on density differences using a medium of a different density or by using another ratio of the same medium/density-adjusting compound to further separate the isolated fraction of amino and/or organic acid-containing particles into subfractions essentially as described hereinabove to hereby again obtain sinking and floating sub-fractions of amino and/or organic acid-containing particles with different compositions.

This can also be achieved in a series of separating units such as settlers in a (semi)-continuous process.

The amino and/or organic acid particles thus obtained typically have a mean particle size from about >10 μm, preferably about >30 μm, more preferably about >100 μm, most preferably about >300 μm.

The amino and/or organic acid particles of this disclosure can be further purified by conventional methods to obtain chemically pure amino and/or organic acids. The amino and/or organic acid particles obtained by the methods of this disclosure may also be used as a food or feed additive.

### Examples

### Example 1

1 g of methionine, histidine and serine crystals were mixed with 10 ml of chloroform and left for 5 minutes to settle in a bottle flask. The crystals from the bottom of the flask were collected and analyzed as pure serine. The density of the chloroform was measured by weight determination of 1 ml pipetted into a container, density being 1.48 g/cm³. The upper half of the fluid including the floating crystals were transferred to another bottle. The density of the medium was adjusted by adding ethanol, 0.2 ml ethanol for each ml of chloroform. After stirring and settling for 5 minutes, crystals were collected from the bottom of the flask and identified as histidine while the crystals that were floating were identified as methionine.

### Example 2

Foam earth is a waste product from the beet sugar industry. It contains phosphate, amino acids, organic acids that have been precipitated by addition of calciumhydroxide to the thin sugar juice. Foam earth was dried and the particles were crushed to fine particles. These particles were suspended in dibromomethane with a density of 2.5 g/cm³. Only minute amounts of particles were found at the bottom of the flask. Adjusting the density to 2.27 using ethanol as described in Example 1, a top layer was formed that floats and a bottom layer was formed. The top layer was separated and diluted with ethanol to a density of 1.9 g/cm³ and again a bottom layer and a top layer were formed. These layers have both been analyzed for the ratio in which the amino acids and organic acids were distributed over the top layer and the bottom layer.

Calcium salts of amino acids glutamine, Gaba (gamma butyric acid), cysteine, ornithine, and citric acid distributed about equal over top and bottom layer. Calcium salts of lysine, lactic and formic acid concentration was factor 2 higher in bottom layer. For aspartic, serine, arginine, glycine, threonine, alanine, valine, isoleucine, phenylalanine, this factor was around 5, while for tyrosine, leucine and glutamic acid, it was higher than 8. Calcium salts of acetic acid and succinic acid were thirteen-fold higher in the bottom layer.

### Example 3: Uric Acid from Poultry Manure

Fresh chicken manure was dried against the air for two days. About 2.2 grams of the dried material was suspended in 7 ml Dibromomethane. All the dried material floated on top of the suspension. There was no precipitate observed, indicating the absence of calciumcarbonate with high density that sometimes is administered to the chicken feed. The density of the liquid phase was lowered by addition of ethanol to about 1.8 g/ml. After centrifugation at this density, an almost white precipitate was visible that was identified as uric acid, while most of the poultry manure was floating on the top of the tube. The uric acid was washed with ethanol and dried. The weight of the sample was 0.12 gram.

### Example 4: Separation of Complex Mixture of 20 Amino Acids at 2-Liter Scale

A glass settler was constructed from a cylindrical top part with a diameter of about 10 cm and a height of about 30 cm and a conical bottom part that has a valve in the bottom to take samples from the bottom. The conical top part contains six valves more or less equally separated vertically to take samples from the top of the cylinder or from somewhere in between top and bottom. The top and the bottom part are connected by a plastic connector to keep the two parts together. The cylinder was filled with 1 liter of dibromomethane and 1.25 liter of ethanol. The temperature was 21° C. The mixture was stirred with a top stirrer for 1 minute. A mixture of dry 20 proteogenic crystalline amino acids was made containing about 5 grams of each amino acid and added to the cylinder from the top. Again, the suspension was stirred for 2 minutes and then the suspension was given time to settle. From valve 3 from the top, a sample liquid was taken and the density was determined to be 1.55 g/ml. A sample of about 120 ml was taken from the bottom. This contained four amino acids: asp, gly, glu and ser. Some small background of the apolar amino acids could be observed. It was concluded that some amino acids had dissolved. 100 ml ethanol was added from the top of the cylinder and the suspension was stirred for 2 minutes and given time to settle. From valve 3 from the top, a sample liquid was taken and the density was determined to be 1.55 g/ml. A sample of about 110 ml was taken from the bottom. Asn and Thr were in this fraction. 140 ml ethanol was added from the top of the cylinder and the suspension was stirred for 2 minutes and given time to settle. From valve 3 from the top, a sample liquid was taken and the density was determined to be 1.51 g/ml. A sample of about 110 ml was taken from the bottom. Asn and thr were in this fraction. 140 ml ethanol was added from the top of the cylinder and the suspension was stirred for 2 minutes and given time to settle. From valve 3 from the top, a sample liquid was taken and the density was determined to be 1.41 g/ml. A sample of about 150 ml was taken from the bottom. Gln, cys and his were in this fraction. 140 ml ethanol was added from the top of the cylinder and the suspension was stirred for 2 minutes and given time to settle. From valve 3 from the top, a sample liquid was taken and the density was determined to be 1.37 g/ml. A sample of about 135 ml was taken from the bottom. Tyr, ala and pro were in this fraction. 250 ml ethanol was added from the top of the cylinder and the suspension was stirred for 2 minutes and given time to settle. From valve 3 from the top, a sample liquid was taken and the density was determined to be 1.31 g/ml. A sample of about 110 ml was taken from the bottom. Arg, Met and Phe were in this fraction. 300 ml of the suspension was taken from the second valve. Ile, Leu, Trp, Val and Lys were in this fraction.

### Example 5: Separation of Anthranylic Acid and Para Amino Benzoic Acid

1 gram of each of anthranylic acid and para amino benzoic acid were suspended in a solution of 5 ml ZnBr2 in water at 77% concentration in a small beaker of 25 ml containing a magnetic stirrer. The density was 2.42 g/ml. All the chemicals float on top of the liquid. Every 2.5 minutes, water was added dropwise until some precipitation started to occur. 12.1 ml of water had been added as determined by the weight increase. The density was measured to be 1.41 g/ml. After 1 ml addition of more water, a precipitate was formed. This precipitate was soaked out by a 1000 μl micropipette from the bottom of the beaker. The density of the suspension was measured to be 1.42 g/ml.

To the remaining liquid, small amounts (200 μl) of water were added by a micropipette, stirred for 1 minute and then 2.5 minutes time to settle and float. No additional precipitate was formed until 800 μl had been added. At this density (about 1.38 g/ml), a top layer as well as additional precipitate were visible. After two more portions of 200 μl of water, stirring and time to settle, no more floating material was observed.

### Example 6: Separation of Hydroxy Acids

Fine powdered crystals of 0.25 gram D-glucuronic acid and 0.25 gram mucic acid were mixed in a centrifuge tube in which 10 grams of dibromomethane was present. Heptanes (about 2 grams) was added in small portions and with occasional mixing until the solids were no longer floating on the solvent mixture but showed a rather uniform suspension throughout the length of the tube. The suspension was centrifuged at 4700 rpm during 2 minutes. A white layer at the top was present and also an off-white precipitate. The top layer was filtered off and identified as D-glucuronic acid by NMR as a mixture of the alpha and beta form. The precipitate was identified by NMR as mucic acid.

1. A method for separating amino and/or organic acid-containing particles from a mixture of amino and/or organic acid-containing particles based on density, the method comprising:
providing a feed of the amino and/or organic acid-containing particles;
providing a medium having a selected density effective for particles of a lower density than the selected density to float in the medium for particles of a higher density than the selected density to sink in the medium;
combining the feed of the amino and/or organic acid-containing particles with the medium; and
separating the amino and/or organic acid-containing particles of the higher density from the amino and/or organic acid-containing particles of the lower density.

2. The method according to claim 1, wherein the difference between lower and higher density is at least 0.01 g/cm³.

3. The method according to claim 1, wherein the medium is selected from the group consisting of halocarbons, preferably fluorinated, brominated, chlorinated, iodinated hydrocarbons, trichlorofluoromethane, 1,1,2,2,tetrafluoromethane chloropentafluoroethane, octafluorocyclobutane, tetrafluoroethane tetrabromoethane, dibromomethane, chloroform, bromoform, diodomethane, 1,10-diododecane, and ammonium and (earth)alkalitungstate and (earth)alkalimetal halide, solutions.

4. The method according to claim 1, wherein the amino and/or organic acid-containing particles comprise salts of amino and/or organic acids.

5. The method according to claim 1, wherein the medium further comprises a density-adjusting compound.

6. The method according to claim 1, wherein the medium has a density (rho) of from 1.1 g/cm³ to 5 g/cm³.

7. The method according to claim 1, wherein the step of separating is performed under ambient gravity.

8. The method according to claim 1, wherein increased gravity is provided by a centrifugal force.

9. The method according to claim 1, wherein the separation is a continuous process.

10. The method according to claim 1, wherein the continuous process is a series of two or more of settlers, centrifuges, hydrocyclones, and separators and combinations thereof.

11. The method according to claim 1, wherein the separated particles are fed into a further separator containing a medium of a different density.

12. The method according to claim 1, wherein the particles have a mean particle size from about >10 μm.

13. Amino and/or organic acid particles obtainable by the method of claim 1.

14. A food, feed, flavor component, or fragrance component or as a chemical building block comprising the amino and/or organic acid particles of claim 13.

15. The method according to claim 2, wherein the difference between lower and higher density is at least 0.05 g/cm³.

16. The method according to claim 2, wherein the difference between lower and higher density is at least 0.1 g/cm³.

17. The method according to claim 6, wherein the medium has a density (rho) of from 1.3 g/cm³ to 3 g/cm³.

18. The method according to claim 6, wherein the medium has a density (rho) of from 1.5 g/cm³ to 2.5 g/cm³.

19. The method according to claim 12, wherein the particles have a mean particle size from about >30 μm.

20. The method according to claim 12, wherein the particles have a mean particle size from about >300 μm.
